(19) United States
(12) Patent Application Publication
(10) Pub. No.: US 2015/0058910 A1
(43) Pub. Date: Feb. 26, 2015

(54) BTV BOX AND METHOD FOR WIRELESS COMMUNICATION OF TELVISION AUDIO

(71) Applicant: KEVIN SEVEUR, Stockbridge, GA (US)

(72) Inventor: KEVIN SEVEUR, Stockbridge, GA (US)

(21) Appl. No.: 13/975,149

(22) Filed: Aug. 23, 2013

(51) Int. Cl. H04N 21/439; H04N 21/41

(52) U.S. Cl. CPC H04N 21/439; H04N 21/4104
USPC 725/133

(57) ABSTRACT

An integrated audio transmission system for receiving television audio signals from their source and transmitting them to a wireless remote receiver wearable by a user. The integrated audio transmission system comprises a device box and headset receiver, wherein the device box can be configured to receive audio signals directly from a television or from a television converter box (or set top box). Regardless of the source, the device box receives audio signals from either HDMI or RCA wires and once audio signals are received by the device box, the audio signals are isolated and prepared to be broadcast by a near field wireless transmitter, and then broadcast. The broadcast audio signals are picked up by the paired headset receiver. The headset receiver processes the audio signal and broadcasts the audio signal over earpiece speakers.

### BACKGROUND OF THE INVENTION

1. Field of the Invention

This invention relates generally to audio video accessories and, more particularly, to an integrated audio transmission system which wireless communicates audio output of a television to a remote headset.

2. Description of the Prior Art

As televisions and home theatre systems have become less costly, and more viewing content has continued to be provided, it has become more common for individuals to have televisions in a plurality of rooms in a residence. Over the years, it has become more and more common for televisions to be placed in bedrooms. A problem which this has caused, however, is that when more than one person shares a bedroom, one person may be trying to sleep while another use of the television disturbs the person trying to sleep. This problem often centers on the sounds of the television programming, such as talking, music and sound effects because while a person trying to sleep can close their eyes to ignore the visual output of the television, a person's ears cannot be simply closed so as to ignore the audio output. If the person watching the television attempts to keep the volume low to minimize any disturbance, it becomes difficult for them to follow or understand their programming. Thus, there remains a need for an integrated audio transmission system which wireless communicates audio output of a television to a remote headset. It would be helpful if such an integrated audio transmission system utilized standard audio output connectors of televisions and home theatre systems. It would be additionally desirable for such an integrated audio transmission system utilize standard audio receiving equipment so as to be useful for a plurality of users at once or for the ability to interchange receiving equipment.

The Applicant's invention described herein provides for an audio transmission system adapted to receive television audio signals from their source and transmit them to a wireless remote receiver wearable by a user. The primary components of Applicant's integrated audio transmission system are a device box and a headset receiver. When in operation, the integrated audio transmission system allows a user to watch television programming, with all the audio of the programming, while eliminating the audible broadcast of said audio which may be distracting to others in the room. As a result, many of the limitations imposed in the prior art are removed.

### SUMMARY OF THE INVENTION

An integrated audio transmission system for receiving television audio signals from their source and transmitting them to a wireless remote receiver wearable by a user. The integrated audio transmission system comprises a device box and headset receiver, wherein the device box can be configured to receive audio signals directly from a television or from a television converter box (or set top box). Regardless of the source, the device box receives audio signals from either HDMI or RCA wires and once audio signals are received by the device box, the audio signals are isolated and prepared to be broadcast by a near field wireless transmitter, and broadcast.

The broadcast audio signals are picked up by the headset receiver. The headset receiver processes the audio signal and broadcasts the audio signal over earpiece speakers.

It is an object of this invention to provide an integrated audio transmission system which wireless communicates audio output of a television to a remote headset.

It is another object of this invention to provide an integrated audio transmission system which utilizes standard audio output connectors of televisions and home theatre systems.

It is yet another object of this invention to provide an integrated audio transmission system which utilizes standard audio receiving equipment so as to be useful for a plurality of users at once or for the ability to interchange receiving equipment.

These and other objects will be apparent to one of skill in the art.

### BRIEF DESCRIPTION OF THE DRAWINGS

FIG. 1 is a process flow of the primary components of an integrated audio transmission system built in accordance with the present invention in a first configuration.

FIG. 2 is a process flow of the primary components of an integrated audio transmission system built in accordance with the present invention in a second configuration.

### DETAILED DESCRIPTION OF THE INVENTION

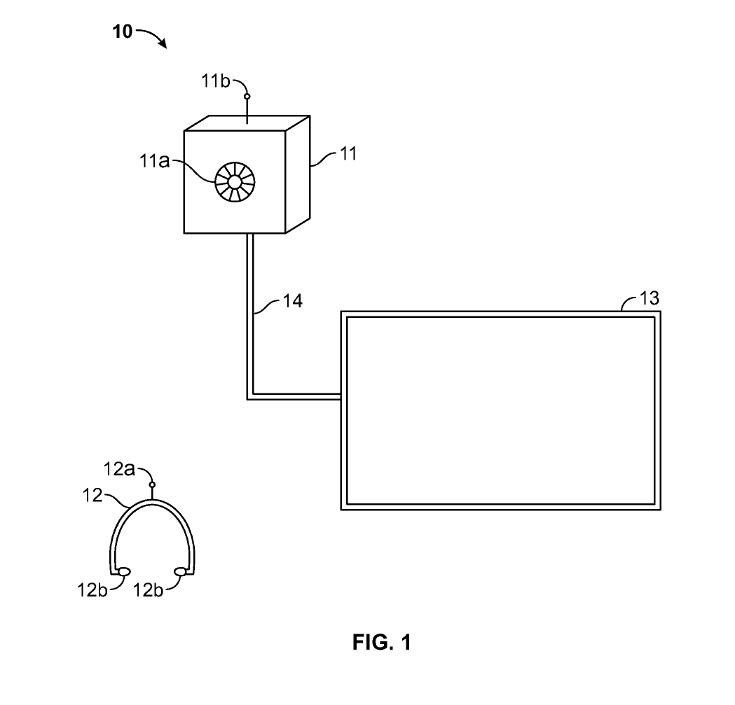

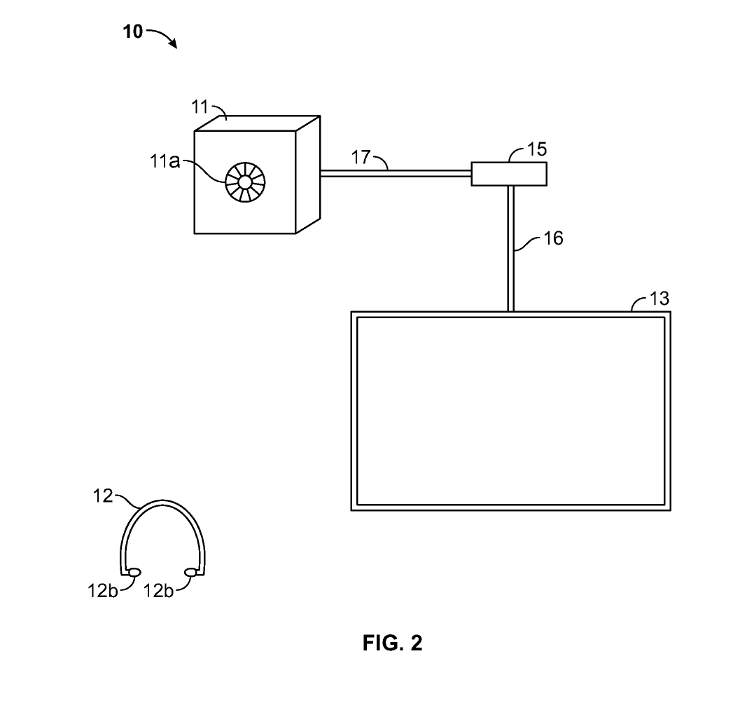

Referring now to the drawings and in particular FIGS. 1 and 2, an integrated audio transmission system 10 is shown as a device box 11 and headset receiver 12. The device box includes a device box input port (not shown) which is adapted to receive raw audio signals, defined as audio signals output from a television set 13 or a television converter box 15, through a device box electronic connector 14, 17. FIG. 1 shows a first configuration wherein the device box 11 is connected directly to a television set 13 through a device box electronic connector 14. FIG. 2 shows a second configuration wherein the device box 11 is connected to a television converter box 15 through an electronic connector 17. In the second configuration, the television converter box 15 connects independently to the television set 13 through a television electronic connector 16 and to the device box input port through the device box electronic connector 17. In the preferred embodiment, the device box electronic connectors 14, 17 are defined as a either a standard HDMI connector or a standard RCA connector and the device box 11 is configured with device box input ports for both HDMI and RCA connectors (only one connector would be used at a given time). It is contemplated that the use of standard HDMI or RCA connectors allows for near universal compatibility with television sets 13 and television converter boxes 15, in contrast to any attempt to employ 3.5 mm or 2.5 mm phone connectors which are commonly used for audio transmissions. Conventional television sets and television converter boxes are generally adapted to output audio (and video in many cases) from one or more HDMI outlets and/or from RCA outlets. Thus, by being adapted to receive either a HDMI connector or a RCA connector wire originating from a television set's 13 or television converter box's 15 respective outlet, raw audio signals are provided to the device box 11 in real time.

Once raw audio signals are received by the device box 11, the device box 11 processes the raw audio signals. Such processing typically includes isolating the audio data from any accompanying video data in the signal received and preparing the isolated audio signal to be broadcast by a near field wireless transmitter, including the performance of any requisite analog to digital conversion (if the isolated audio signal is an analog signal) and the performance of isolated audio signal conditioning. The device box's 11 internal components include a power source (not shown), a controller (not shown), a signal isolator component (not shown), an analog to digital conversion component (not shown), and a signal conditioning component (not shown) to facilitate the performance of these functions.

It is contemplated that since the device box 11 is adapted to functionally pass along the isolated audio signal from its source (as in the television set 13 in the first configuration and the television converter box 15 in the second configuration), it is desirable to condition the isolated audio signal so that the volume output from the integrated audio transmission system 10 can be adjusted by the device box 11 and wholly correspond to a volume level output set by the television set 13 (or the television converter box 15). As a result, if the volume level output in television set's 13 raw audio signal output remains constant regardless of the actual volume level of the television set 13, the volume of the television set 13 can to be turned off completely while the volume level produced by the integrated audio transmission system 10 remains selectively adjustable up or down as desired by the user. In contrast, if volume level output in television set's 13 raw audio signal output adjusts as the actual in relation to the volume level of the television set 13 does, such conditioning allows the volume level to be normalized so as to again be controlled (increased or decreased) by the device box 11. Consequently, in such a circumstance, a user can lower the volume level nearly all the way down on the television set 13 and then independently raise the volume output by the integrated audio transmission system 10. In the preferred embodiment, the device box 11 includes a volume adjusting manual actuator 11a which allows for the selective local adjustment of the volume level output by the integrated audio transmission system 10.

Once the processing of the isolated audio signals is complete, a processed audio signal is passed to a near field communication transmitter 11b, such as a Bluetooth transmitter as used in the preferred embodiment, where it is broadcast to be received by the headset receiver 12. The headset receiver 12 includes a power source, a controller, a Bluetooth receiver 12a, a digital to analog conversion component (not shown), and a headset output mechanism, defined as two earpiece speakers 12b. Prior to operation, the headset receiver 12 is paired with the device box 11 using standard Bluetooth protocols. The headset receiver 12 operates by receiving the processed audio signal transmitted by the near field communication transmitter 11b, format the processed audio signal by converting the processed audio signal to an analog format, and broadcasting the analog processed audio signal over the speakers 12b.

It is contemplated that because a Bluetooth transmitter is used by the device box 11, any suitable Bluetooth compatible receiver, including earpieces and speakers, could be paired with the device box and utilized therewith.

In the preferred embodiment, the power source of the device box 11 is a corded connection to an A/C wall plug and the power source of the headset receiver 12 is a rechargeable battery. In such an embodiment, the headset receiver 12 includes a port, defined as a USB port, to avail itself to electrical power from outside sources in order to recharge its battery.

In an alternate embodiment, either the near field communication transmitter 1 lb or the Bluetooth receiver 12a are embodied as internal antennae within the device box 11 and the headset receiver 12, respectively. Such an embodiment is exemplified in FIG. 2.

In another alternate embodiment, the device box is integrated with a television set. In yet another alternate embodiment, the device box is integrated a television converter box

The instant invention has been shown and described herein in what is considered to be the most practical and preferred embodiment. It is recognized, however, that departures may be made therefrom within the scope of the invention and that obvious modifications will occur to a person skilled in the art.

1. An integrated audio transmission system, comprising:
a device box having at least one device box input port, a power source, an internal controller, an internal signal isolator component, an internal analog to digital conversion component, and an internal signal conditioning component, and a near field communication transmitter, wherein each device box input port is configured to receive raw audio signals through a standardized electronic connector, generate processed audio signals from said raw audio signals, thereby enabling the volume level produced by the integrated audio transmission system to be controlled independent of the volume level of the raw audio signals, and broadcast said processed audio signals over the near field communication transmitter; and
a remote headset receiver having a power source, a controller, a near field communication receiver, a digital to analog conversion component, and a headset output mechanism, wherein said headset receiver is configured to receive said processed audio signals through the near field communication receiver, format the processed audio signal, and broadcast the processed audio signal over the headset output mechanism.

2. The integrated audio transmission system of claim 1, wherein one of said device box input ports is adapted to receive raw audio signals through a HDMI connector.

3. The integrated audio transmission system of claim 2, wherein one of said device box input ports is adapted to receive raw audio signals through a RCA connector.

4. The integrated audio transmission system of claim 1, wherein:
said near field communication transmitter is a Bluetooth transmitter; and
said near field communication receiver is a Bluetooth receiver.

5. The integrated audio transmission system of claim 1, wherein the generation of processed audio signals from raw audio signals includes isolating the audio data from any accompanying video data in the raw audio signal.

6. The integrated audio transmission system of claim 1, wherein the generation of processed audio signals from raw audio signals includes performing an analog to digital conversion.

7. The integrated audio transmission system of claim 1, wherein the generation of processed audio signals from raw audio signals includes performing of audio signal conditioning.

8. The integrated audio transmission system of claim 1, wherein the formatting of the processed audio signal includes converting the processed audio signal to an analog format.

9. The integrated audio transmission system of claim 1, wherein the device box is integrated with a television set.

10. The integrated audio transmission system of claim 1, wherein the device box is integrated with a television converter box.

11. The integrated audio transmission system of claim 1, wherein the headset output mechanism is at least one speaker.

12. A method for receiving television audio signals from their source and transmitting them to a wireless remote receiver wearable by a user, comprising the steps of:
providing a device box having at least one device box input port, a power source, an internal controller, an internal signal isolator component, an internal analog to digital conversion component, and an internal signal conditioning component, and a near field communication transmitter, wherein each device box input port is configured to receive raw audio signals through a standardized electronic connector;
providing a remote headset receiver having a power source, a controller, a near field communication receiver, a digital to analog conversion component, and a headset output mechanism, wherein said headset receiver is configured to receive said processed audio signals through the near field communication receiver;
providing raw audio signals from to one of said device box input ports;
generating by said device box processed audio signals from said raw audio signals, wherein the step of generating includes performing audio signal conditioning such that the volume output resulting from processed audio signals can be adjusted irrespective of the volume level of the raw audio signals;
broadcasting by said device box said processed audio signals over the near field communication transmitter;
receiving by said headset receiver said processed audio signals through the near field communication receiver;
formatting by said headset receiver the processed audio signal; and
broadcasting by said headset receiver the processed audio signal over the headset output mechanism.

13. The method for receiving television audio signals from their source and transmitting them to a wireless remote receiver wearable by a user of claim 12, wherein one of said device box input ports is adapted to receive raw audio signals through a HDMI connector.

14. The method for receiving television audio signals from their source and transmitting them to a wireless remote receiver wearable by a user of claim 12, wherein one of said device box input ports is adapted to receive raw audio signals through a RCA connector.

15. The method for receiving television audio signals from their source and transmitting them to a wireless remote receiver wearable by a user of claim 12, wherein:
said near field communication transmitter is a Bluetooth transmitter; and
said near field communication receiver is a Bluetooth receiver.

16. The method for receiving television audio signals from their source and transmitting them to a wireless remote receiver wearable by a user of claim 12, wherein the step of generating additionally includes:
isolating the audio data from any accompanying video data in the raw audio signal; and
performing an analog to digital conversion.

17. The method for receiving television audio signals from their source and transmitting them to a wireless remote receiver wearable by a user of claim 12, wherein the step of formatting includes converting the processed audio signal to an analog format.

18. The method for receiving television audio signals from their source and transmitting them to a wireless remote receiver wearable by a user of claim 12, wherein the device box is integrated with a television set.

19. The method for receiving television audio signals from their source and transmitting them to a wireless remote receiver wearable by a user of claim 12, wherein the device box is integrated with a television converter box.

20. The method for receiving television audio signals from their source and transmitting them to a wireless remote receiver wearable by a user of claim 12, wherein the headset output mechanism is at least one speaker.
